(19) United States
(12) Patent Application Publication
(10) Pub. No.: US 2023/0151255 A1
(43) Pub. Date: May 18, 2023

(54) MULTILAYER STRUCTURE FOR TRANSPORTING OR STORING HYDROGEN

(71) Applicant: ARKEMA FRANCE, Colombes (FR)

(72) Inventors: Nicolas DUFAURE, Serquigny (FR); Antoine GOUPIL, Seoul (KR); Olivier MERLE, Colombes Cedex (FR)

(73) Assignee: ARKEMA FRANCE, Colombes (FR)

(21) Appl. No.: 17/917,052

(22) PCT Filed: Apr. 15, 2021
(86) PCT No.: PCT/FR2021/050657

§ 371 Date: Oct. 5, 2022

(30) Foreign Application Priority Data
Apr. 16, 2020 (FR) 2003818

(51) Int. Cl. C09K 3/10; C08G 69/10; C08G 69/36; C08J 5/24; F17C 1/16; B32B 1/02; B32B 5/02; B32B 27/12; B32B 27/34

(52) U.S. Cl. CPC C09K 3/1028; C08G 69/10; C08G 69/36; C08J 5/243; F17C 1/16; B32B 1/02; B32B 5/02; B32B 27/12; B32B 27/34; C09K 2003/1084; C09K 2200/0667; C09K 2200/0647; C09K 2200/0282; C08J 2363/00; C08J 2377/04; C08J 2377/06; F17C 2221/012; F17C 2203/012; F17C 2203/0673; F17C 2203/066; F17C 2209/2118; F17C 2209/2127; F17C 2209/232; B32B 2439/40; B32B 2260/023; B32B 2260/046; B32B 27/18

(57) ABSTRACT

The use of a sealing layer of a composition including at least one polyamide for preparing a multicore structure intended for the transport, distribution or storage of hydrogen, in particular for the distribution or storage of hydrogen, especially for the storage of hydrogen, the sealing layer satisfying a test for contaminants present in the hydrogen and extracted from the sealing layer after contact of the hydrogen with same, the test been carried out as defined in the standard CSA/ANSI CHMC 2: 19, the total proportion of said contaminants extracted in the hydrogen being less than or equal to 3% by weight, in particular less than 2% by weight of the sum of the constituents of the composition.

### TECHNICAL FIELD

The present patent application relates to multilayer structures intended for the transport, distribution or storage of hydrogen, in particular for the distribution or storage of hydrogen, especially for the storage of hydrogen, comprising a sealing layer composed of a composition of polyamide and the use of said sealing layer satisfying a test for contaminants present in the hydrogen and extracted from said sealing layer by the hydrogen, and their method of manufacture.

### PRIOR ART

Hydrogen tanks are currently attracting a lot of attention from numerous manufacturers, especially in the automotive sector. One of the goals sought is to propose increasingly fewer polluting vehicles. Thus, electric or hybrid vehicles comprising a battery aim to progressively replace combustion engine vehicles such as either gas or diesel vehicles. It has turned out that the battery is a relatively complex vehicle component. Depending on the positioning of the battery in the vehicle, it may be necessary to protect it from impact and from the outside environment, which can have extreme temperatures and variable humidity. It is also necessary to avoid any risk of flames.

Additionally, it is important that the operating temperature thereof not exceed 55° C. in order to not break down the cells of the battery and to preserve the life thereof. Conversely, for example in winter, it may be necessary to increase the battery temperature so as to optimize operation thereof.

Moreover, electric vehicles still suffer today from several problems, namely battery range, the use in these batteries of rare earth metals, the resources for which are not infinite, much longer recharging times than the length of time taken to fill a tank, as well as a problem of electricity production in various countries in order to be able to recharge the batteries.

Hydrogen is therefore an alternative to the electric battery since hydrogen can be converted into electricity by means of a fuel cell and thus power electric vehicles.

The supply of hydrogen for the fuel cell therefore requires the presence of both a hydrogen storage tank in the vehicle and a pipe for transporting the hydrogen from the tank to the fuel cell.

Hydrogen tanks or hydrogen transport pipes generally consist of a metallic or thermoplastic liner (or sealing layer) that must prevent hydrogen from permeating out. One of the types of tank envisaged, referred to as Type IV, is based on a thermoplastic liner around which a composite is wound.

Their basic principle is to separate the two essential functions of sealing and mechanical strength and manage them independently of each other. In this type of tank, the liner (or sealing sheath) made of thermoplastic resin is combined with a reinforcement structure consisting of fibers (glass, aramid, carbon) also known as a reinforcement sheath or layer, which makes it possible to operate at much higher pressures while reducing weight and avoiding risks of explosive rupture in the event of severe external attacks.

The problem is identical for the transport pipe.

The liners must have certain fundamental characteristics:

The possibility to be transformed by extrusion blow molding, rotational molding, injection molding or extrusion
Low permeability to hydrogen, indeed, the permeability of the liner is a key factor in limiting hydrogen losses from the tank;
Good mechanical properties (fatigue) at low temperatures (−40 to −70° C.);
Thermal resistance at 120° C.

However, the fuel cell is very sensitive to various contaminants which degrade its performance and its durability.

These contaminants can originate from several sources:

from the hydrogen itself due to the method of making same,
from the manufacture of the tank and/or the hydrogen transport pipe where different natural constituents such as volatile organic compounds or water get trapped in the thermoplastic polymer of the sealing layer, and which will subsequently be extracted by the hydrogen upon contact with said sealing layer,
from the presence in the thermoplastic polymer of constituents which are able to be subsequently extracted by the hydrogen upon contact with said sealing layer.

According to Chen et al. (A review of PEM hydrogen fuel cell contamination: impact, mechanisms and mitigation, Journal of Power Sources, 165 (2007), 739-756), the hydrogen used as fuel in the fuel cells in research, development and demonstration principally originate from commercially available sources. The methods for producing hydrogen are mainly performed by reforming from hydrocarbons or oxygenated hydrocarbons, including methane from natural gas and methanol from biomass, but also by electrolysis, partial oxidation of small organic molecules and hydrolysis of sodium borohydride.

Consequently, a hydrogen tank or transport pipe used with a fuel cell must not only have the basic features listed above but also the hydrogen, after contact with the sealing layer of said tank and/or pipe, must only contain minimal contaminants extracted from said sealing layer.

This two-fold problem is solved by providing a multilayer structure of the present invention intended for transporting, distributing or storing hydrogen

Throughout this description, the terms “liner” and “sealing sheath” have the same meaning.

The present invention therefore relates to the use of a sealing layer (1) consisting of a composition comprising at least one polyamide for preparing a multilayer structure intended for the transport, the distribution or the storage of hydrogen, in particular for the distribution or the storage of hydrogen, especially for the storage of hydrogen, said sealing layer satisfying a test for contaminants present in the hydrogen and extracted from the sealing layer after contact of the hydrogen with same, the test being carried out as defined the in standard CSA/ANSI CHMC 2:19, the total proportion of said contaminants extracted in the hydrogen being less than or equal to 3% by weight, in particular less than 2% by weight of the sum of the constituents of the composition.

The Inventors have therefore found that a sealing layer (1) consisting of a composition comprising at least one polyamide made it possible to prepare a multilayer structure intended for the transport, distribution or storage of hydrogen, having the basic features listed above but that it also made it possible to limit the proportion of contaminants present in the hydrogen and extracted after contact of the hydrogen with said sealing layer.

By “multilayer structure” a tank comprising or consisting of several layers should be understood, namely several sealing layers and several reinforcement layers, or one sealing layer and several reinforcement layers, or several sealing layers and a reinforcement layer or a sealing layer and a reinforcement layer.

The multilayer structure in the present invention also denotes a pipe or a tube intended for transporting hydrogen from the tank to the fuel cell and which comprises or consists of several layers, namely several sealing layers and several outer layers, or one sealing layer and several outer layers, or several sealing layers and one outer layer or one sealing layer and one outer layer.

The expression “said sealing layer satisfying a test for contaminants present in the hydrogen and extracted from the sealing layer by the hydrogen” means that the proportion of contaminants present in the hydrogen and originating from the sealing layer after contact with the hydrogen, whether this is a tank or a pipe, does not exceed the limit values preventing the correct functioning of the fuel cell.

Standard CSA/ANSI CHMC 2:19 gives details about the procedure used to determine the volatile components in the headspace of a polymer during exposure to the hydrogen during service.

The expression “after contact of the hydrogen with same” means, just like above, exposure to the hydrogen during service.

### Equipment

The test equipment must comprise the following elements:

a) a cryofocus to pre-concentrate the gas samples;
b) a gas chromatograph using an appropriate column, connected in series with an appropriate mass-selective detector;
c) headspace vials (40 ml), septa, ring closures and seals for vials;
d) an analytical balance able to weigh up 60.0001 g; and
e) a convection oven able to maintain a temperature of 70±5° C.

### Test Environment

### Hydrogen Gas Purity

The hydrogen packaging gas must be of known composition and purity, as described below.

The purity of the hydrogen gas used to fill the test chamber must, as a minimum, comply with standard ISO 14687:2019, parts 1 to 3, or SAE J2719 (2015). ISO 14687-2 defines the strictest quality specification of the hydrogen, with the lowest threshold values for each impurity among these ISO standards (see table 1). SAE J2719 also applies to vehicles with proton exchange membrane (PEM) fuel cells and is harmonized with ISO 14687-2.

TABLE 1

| Characteristics | | Limit |
|---|---|---|
| Fuel index | Minimum molar | 99.97% |
| | fraction | |
| Non-hydrogen gas | — | 300 |
| total | | |

Maximum concentration of individual contaminants

| | | |
|---|---|---|
| Water | H2O | 5 |
| Hydrocarbon total | CH4 base | 2 |
| Methane | CH4 | 100 |
| Oxygen | O2 | 5 |
| Helium | He | 300 |
| Nitrogen and argon | N2, Ar | 300 |
| total | | |
| Carbon dioxide | CO2 | 2 |
| Carbon monoxide, | Σ CO + CH₂O + | 0.2 |
| formaldehyde, and | CH₂O₂ | |
| formic acid total | | |
| Carbon monoxide | CO | 0.2 |
| Formaldehyde | CH2O | 0.2 |
| Formic acid | CH2O2 | 0.2 |
| Sulfur compounds | H2S base | 0.004 |
| total | | |
| Ammonia | NH3 | 0.1 |
| Halogen compounds | — | 0.05 |
| total | | |
| Maximum particle | — | 1 mg/kg |
| concentration (liquid | | |
| and solid) | | |

* all values are given in ppm (v/v) unless otherwise specified
† when the values given in this Table 1 differ from the current version of standard ISO 14687-2:2019, the current values apply.

### Measuring and Instrumentation

The temperature at which the measurements of the hydrogen transmission speed are taken must be controlled to within ±1° C. The test pressure must remain constant within 1% of the test value.

### Test Procedure

The test procedure is described in standard ISO 14687:2019 in paragraph 5.6.

### Regarding the Contaminants

The term contaminant is understood in the broadest sense of the term from the moment when said contaminant is extracted from said sealing layer by the hydrogen and is not already present in the hydrogen that is introduced into said multilayer structure to make the fuel cell of the vehicle function, for example due to the method for obtaining the hydrogen.

For example, the term contaminant covers metal cations such as K⁺, Cu²⁺, Ni²⁺ and Fe³⁺ which can be produced by the stabilizers used in the polyamides, the organic or metal stabilizers as such, the plasticizers, the oligomers, in particular caprolactam and its cyclic dimer 1,8-diazacyclotetradecane-2,7-dione (DCDD), the volatile organic compounds such as NH3, NOx, SOx, N2, benzoic compounds, O3, the water absorbed by the polyamide after manufacturing the sealing layer, the fatty substances such as oil.

Volatile organic compounds therefore exclude all the other materials cited in the list above.

The total proportion of said contaminants extracted in the hydrogen is less than or equal to 3% by weight, in particular less than 2% by weight of the sum of the constituents of said composition. Consequently, this total proportion of said extracted contaminants does not take into account the proportion of contaminants which would originate from the method for preparing the hydrogen or any other source.

Advantageously, the total proportion of said contaminants extracted in the hydrogen is comprised from 0.01% to 3%, in particular from 0.01% to 2%, more particularly from 0.01% to 1%, especially from 0.01% to 0.5% by weight.

In a first variant, the contaminants extracted are selected from the plasticizers, the stabilizers, the oligomers, water, a fatty substance, volatile organic compounds and a mixture thereof.

Advantageously, in this first variant, the proportion by weight of each individual contaminant extracted is less than or equal to 1%.

In an embodiment of this first variant, the constitution of the contaminants extracted is the following:

up to 1% of plasticizers,
up to 0.5% of stabilizers,
up to 0.5% of oligomers,
up to 0.5% of water,
up to 0.5% of fatty substance, and
up to 0.5% of volatile organic compounds,
the sum of the extracted contaminants being less than or equal to 3%, in particular less than 2% by weight of the sum of the constituents of said composition.

Advantageously, in this embodiment of this first variant, the total proportion of said contaminants extracted in the hydrogen is comprised from 0.01% to 3%, in particular from 0.01% to 2%, more particularly from 0.01% to 1%, especially from 0.01% to 0.5% by weight.

More advantageously, in this embodiment of this first variant, the proportion by weight of each individual contaminant extracted is less than or equal to 1%.

In a second variant, the extracted contaminants are selected from the stabilizers, water, oil, volatile organic compounds and a mixture thereof.

Advantageously, in this second variant, the proportion by weight of each individual extracted contaminant is less than or equal to 0.5%.

In an embodiment of this second variant, the constitution of the extracted contaminants is the following:

up to 0.5% of stabilizers,
up to 0.5% of water,
up to 0.5% of fatty substance, and
up to 0.5% of volatile organic compounds,
the sum of the contaminants being less than or equal to 2% by weight of the sum of the constituents of said composition.

Advantageously, in this embodiment of this second variant, the total proportion of said contaminants extracted in the hydrogen is comprised from 0.01% to 2%, more particularly from 0.01% to 1%, especially from 0.01% to 0.5% by weight.

More advantageously, in this embodiment of this second variant, the proportion by weight of each individual contaminant extracted is less than or equal to 0.5%.

### Regarding the Composition

In a first embodiment, the composition which constitutes said sealing layer (1), especially in the first variant defined above, comprises by weight:

at least 63.5% of polyamide,
from 0 to 30% of impact modifier, especially from 0 to less than 15% of impact modifier, in particular from 0 to 12% of impact modifier,
from 0 to 1.5% of plasticizer, and
from 0 to 5% by weight of additives,
the sum of the constituents of the composition being equal to 100%.

Advantageously, said composition of this first embodiment comprises from 1 to 30% of impact modifier, especially from 1 to less than 15% of impact modifier, in particular from 1 to 12% of impact modifier.

Advantageously, said composition of this first embodiment comprises from 0.1 to 1.5% of plasticizer.

Advantageously, said composition of this first embodiment comprises from 0.1 to 5% by weight of additives

Advantageously, said composition of this first embodiment comprises from 1 to 30% of impact modifier, especially from 1 to less than 15% of impact modifier, in particular from 1 to 12% of impact modifier and from 0.1 to 1.5% of plasticizer.

Advantageously, said composition of this first embodiment comprises from 1 to 30% of impact modifier, especially from 1 to less than 15% of impact modifier, in particular from 1 to 12% of impact modifier and from 0.1 to 5% by weight of additives.

Advantageously, said composition of this first embodiment comprises from 0.1 to 1.5% of plasticizer and from 0.1 to 5% by weight of additives

Advantageously, said composition of this first embodiment comprises from 1 to 30% of impact modifier, especially from 1 to less than 15% of impact modifier, in particular from 1 to 12% of impact modifier, from 0.1 to 1.5% of plasticizer and from 0.1% to 5% by weight of additives.

In a second embodiment, the composition which constitutes said sealing layer (1), especially in the first variant defined above, consists by weight:

of at least 63.5% of polyamide,
of from 0 to 30% of impact modifier, especially from 0 to less than 15% of impact modifier, in particular from 0 to 12% of impact modifier,
of from 0 to 1.5% of plasticizer, and
of from 0 to 5% by weight of additives,
the sum of the constituents of the composition being equal to 100%.

Advantageously, said composition of this second embodiment comprises from 1 to 30% of impact modifier, especially from 1 to less than 15% of impact modifier, in particular from 1 to 12% of impact modifier.

Advantageously, said composition of this second embodiment comprises from 0.1 to 1.5% of plasticizer.

Advantageously, said composition of this second embodiment comprises from 0.1 to 5% by weight of additives.

Advantageously, said composition of this second embodiment comprises from 1 to less than 15% of impact modifier, in particular from 1 to 12% of impact modifier and from 0.1 to 1.5% of plasticizer.

Advantageously, said composition of this second embodiment comprises from 1 to less than 15% of impact modifier, in particular from 1 to 12% of impact modifier and from 0.1 to 5% by weight of additives.

Advantageously, said composition of this second embodiment comprises from 0.1 to 1.5% of plasticizer and from 0.1 to 5% by weight of additives.

Advantageously, said composition of this second embodiment comprises from 1 to 30% of impact modifier, especially from 1 to less than 15% of impact modifier, in particular from 1 to 12% of impact modifier, from 0.1 to 1.5% of plasticizer and from 0.1% to 5% by weight of additives.

In a third embodiment, the composition which constitutes said sealing layer (1), especially in the second variant defined above, comprises by weight:

at least 63.5% of polyamide,
from 0 to 30% of impact modifier, especially from 0 to less than 15% of impact modifier, in particular from 0 to 12% of impact modifier, and
from 0 to 5% by weight of additives,
the sum of the constituents of the composition being equal to 100%.

Advantageously, said composition of this third embodiment comprises from 1 to 30% of impact modifier, especially from 1 to less than 15% of impact modifier, in particular from 1 to 12% of impact modifier.

Advantageously, said composition of this third embodiment comprises from 0.1 to 5% by weight of additives.

Advantageously, said composition of this third embodiment comprises from 1 to 30% of impact modifier, especially from 1 to less than 15% of impact modifier, in particular from 1 to 12% of impact modifier and from 0.1 to 5% by weight of additives.

In a fourth embodiment, the composition which constitutes said sealing layer (1), especially in the second variant defined above, consists by weight:

of at least 63.5% of polyamide,
of from 0 to 30% of impact modifier, especially from 0 to less than 15% of impact modifier, in particular from 0 to 12% of impact modifier, and
of from 0 to 5% by weight of additives,
the sum of the constituents of the composition being equal to 100%.

Advantageously, said composition of this fourth embodiment comprises from 1 to 30% of impact modifier, especially from 1 to less than 15% of impact modifier, in particular from 1 to 12% of impact modifier.

Advantageously, said composition of this fourth embodiment comprises from 0.1 to 5% by weight of additives.

Advantageously, said composition of this fourth embodiment comprises from 1 to 30% of impact modifier, especially from 1 to less than 15% of impact modifier, in particular from 1 to 12% of impact modifier and from 0.1 to 5% by weight of additives.

### Regarding the Polyamide

The nomenclature used to define the polyamides is described in ISO standard 1874-1:2011 “Plastiques—Matériaux polyamides (PA) pour moulage et extrusion—Partie 1: Désignation”, especially on page 3 (Tables 1 and 2) and is well known to the person skilled in the art.

The polyamide may be a homopolyamide or a co-polyamide or a mixture thereof.

The polyamide is a semi-crystalline polymer, that is to say a material that is generally solid at ambient temperature, and which softens during a temperature increase, in particular after passing its glass transition temperature (Tg), and may exhibit a sharp transition upon passing what is referred to as its melting point (Tm), and which becomes solid again when the temperature decreases below its crystallization temperature.

The Tg, the Tc and the Tm are determined by differential scanning calorimetry (DSC) according to standard 11357-2:2013 and 11357-3:2013, respectively.

The number-average molecular weight Mn of said semi-crystalline polyamide is preferably in a range extending from 10,000 to 85,000, especially from 10,000 to 60,000, preferentially from 10,000 to 50,000, even more preferentially from 12,000 to 50,000. These Mn values may correspond to inherent viscosities greater than or equal to 0.8, as determined in m-cresol according to standard ISO 307:2007 but by changing the solvent (use of m-cresol instead of sulfuric acid and the temperature being 20° C.).

In one embodiment, the polyamide is selected from an aliphatic polyamide, a semi-aromatic polyamide and a mixture of both, advantageously an aliphatic polyamide.

Said aliphatic polyamide can originate from the polycondensation of at least one C₆ to C₁₈, preferentially C₉ to C₁₈, more preferentially C₁₀ to C₁₈, even more preferentially C₁₀ to C₁₂, in particular C₁₁ amino acid; or of at least one C₆ to C₁₈, preferentially C₉ to C₁₈, more preferentially C₁₀ to C₁₈, even more preferentially C₁₀ to C₁₂, in particular C₁₂ lactam; or of at least one C₄ to C₃₆, in particular C₆ to C₃₆, preferentially C₆ to C₁₈, preferentially C₆ to C₁₂, more preferentially C₁ to C₁₂ Ca aliphatic diamine with at least one C₄ to C₃₆, in particular C₆ to C₃₆, preferentially C₆ to C₁₈, preferentially C₁₀ to C₁₈, more preferentially C₁₀ to C₁₂ Cb aliphatic diamine.

A C₆ to C₁₂ amino acid is in particular 6-aminohexanoic acid, 9-aminononanoic acid, 10-aminodecanoic acid, 10-aminoundecanoic acid, 12-aminododecanoic acid and 11-aminoundecanoic acid and derivatives thereof, especially N-heptyl-11-aminoundecanoic acid.

When said at least one semi-crystalline aliphatic polyamide is obtained from the polycondensation of at least one lactam, it may therefore comprise a single amino acid or several amino acids.

Advantageously, said semi-crystalline aliphatic polyamide is obtained from the polycondensation of a single amino acid and said amino acid is selected from 11-aminoundecanoic acid and 12-aminododecanoic acid, advantageously 11-aminoundecanoic acid.

The C₆ to C₁₂ lactam is especially caprolactam, decanolactam, undecanolactam, and lauryllactam.

When said at least one semi-crystalline aliphatic polyamide is obtained from the polycondensation of at least one lactam, it may therefore comprise a single lactam or several lactams.

Advantageously, said at least one semi-crystalline aliphatic polyamide is obtained from the polycondensation of a single lactam and said lactam is selected from lauryllactam and undecanolactam, advantageously lauryllactam.

The Ca diamine may be linear or branched. Advantageously, it is linear.

Said at least one C₄-C₃₆ Ca diamine can be in particular selected from butanemethylenediamine, 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and the diamines obtained from fatty acids.

Advantageously, said at least one C6-C36 Ca diamine is selected from 1,6-hexamethylenediamine, 1,7-heptamethylenediamine, 1,8-octamethylenediamine, 1,9-nonamethylenediamine, 1,10-decamethylenediamine, 1,11-undecamethylenediamine 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and the diamines obtained from fatty acids.

Said at least one C₄ to C₃₆ dicarboxylic acid Cb may be selected from butanedioic acid, pentanedioic acid, adipic acid acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid, and diacids obtained from fatty acids.

The diacid may be linear or branched. Advantageously, it is linear.

Advantageously, the aliphatic polyamide is selected from PA6, PA66, PA11, PA12, PA610, PA612, PA1010, PA1012 and PA1212.

Said semi-aromatic polyamide can be, especially, a semi-aromatic polyamide with formula X/YAr, as described in EP1505099, especially a semi-aromatic polyamide with formula A/XT in which A is selected from a unit obtained from an amino acid as defined hereinbefore, a unit obtained from a lactam as defined hereinbefore and a unit corresponding to the formula (Cc diamine).(Cd diacid), with c representing the number of carbon atoms of the diamine and d representing the number of carbon atoms of the diacid, c and d each being between 4 and 36, advantageously between 9 and 18, the (Cc diamine) unit being selected from linear or branched aliphatic diamines, as defined hereinbefore, cycloaliphatic diamines and alkylaromatic diamines and the (Cd diacid) unit being selected from linear or branched aliphatic diacids, as defined hereinbefore, cycloaliphatic diacids and aromatic diacids;

X.T denotes a unit obtained from the polycondensation of a Cx diamine and terephthalic acid, with x representing the number of carbon atoms of the Cx diamine, x being between 5 and 36, advantageously between 9 and 18, especially a polyamide with formula A/5T, A/6T, A/9T, A/10T, or A/11T, A being as defined above, in particular a polyamide chosen from among a PA MPMDT/6T, a PA11/10T, a PA 5T/10T, a PA 11/BACT, a PA 11/6T/10T, a PA MXDT/10T, a PA MPMDT/10T, a PA BACT/10T, a PA BACT/6T, PA BACT/10T/6T, a PA 11/BACT/6T, PA 11/MPMDT/6T, PA 11/MPMDT/10T, PA 11/BACT/10T, a PA 11/MXDT/10T, an 11/5T/10T.
T corresponds to terephthalic acid, MXD corresponds to m-xylylene diamine, MPMD corresponds to methylpentamethylene diamine and BAC corresponds to bis(aminomethyl)cyclohexane.

Said semi-aromatic polyamide can also be a polyamide with formula ZAr, wherein Z is a unit obtained from the polycondensation of at least one Ca aliphatic diamine as defined hereinbefore and Ar is an aromatic dicarboxylic acid, in particular terephthalic acid, isophthalic acid and naphthalene acid.

In one embodiment, the polyamide is aliphatic and selected from PA6, PA66, PA11, PA12, PA610, PA612, PA1010, PA1012 and PA1212.

In another embodiment, the polyamide is semi-aromatic and chosen from polyamide 11/5T, 11/6T, 11/10T, MXDT/10T, MPMDT/10T and BACT/10T.

In one embodiment, said polyamide of said composition is previously washed at least once with a system selected from a polar solvent, in particular methanol, water or water vapor, or a mixture thereof.

### Regarding the Impact Modifier

The impact modifier may be any impact modifier as long as it is a polymer having a modulus below that of the resin, having good adhesion to the matrix, so as to dissipate cracking energy.

The impact modifier advantageously consists of a polymer having a flexural modulus below 100 MPa measured according to standard ISO 178 and a Tg below 0° C. (measured according to standard 11357-2 at the inflection point of the DSC thermogram), in particular a polyolefin.

In one embodiment, PEBAs are excluded from the definition of impact modifiers.

The polyolefin of the impact modifier may be functionalized or non-functionalized or be a mixture of at least one functionalized polyolefin and/or least one non-functionalized polyolefin. To simplify, the polyolefin is denoted (B) and functionalized polyolefins (B1) and non-functionalized polyolefins (B2) are described below.

A non-functionalized polyolefin (B2) is classically a homopolymer or copolymer of alpha-olefins or diolefins, such as for example, ethylene, propylene, 1-butene, 1-octene, butadiene. By way of example, mention may be made of:
the homopolymers and copolymers of polyethylene, particularly LDPE, HDPE, LLDPE (linear low-density polyethylene), VLDPE (very low density polyethylene) and metallocene polyethylene.
homopolymers or copolymers of propylene.
ethylene/alpha-olefin copolymers such as ethylene/propylene, EPR (abbreviation for ethylene-propylene-rubber) and ethylene/propylene/diene (EPDM).
styrene/ethylene-butene/styrene (SEBS), styrene/butadiene/styrene (SBS), styrene/isoprene/styrene (SIS), styrene/ethylene-propylene/styrene (SEPS) block copolymers.
copolymers of ethylene with at least one product chosen from the salts or esters of unsaturated carboxylic acids such as alkyl (meth)acrylate (for example methyl acrylate), or the vinyl esters of saturated carboxylic acids such as vinyl acetate (EVA), the proportion of comonomer being able to reach 40% by weight.

The functionalized polyolefin (B1) may be a polymer of alpha-olefins having reactive units (functionalities); such reactive units are acid, anhydride, or epoxy functions. Byway of example, mention may be made of the preceding polyolefins (B2) grafted or co- or ter-polymerized by unsaturated epoxides such as glycidyl (meth)acrylate, or by carboxylic acids or the corresponding salts or esters such as (meth)acrylic acid (which can be completely or partially neutralized by metals such as Zn, etc.) or even by carboxylic acid anhydrides such as maleic anhydride. A functionalized polyolefin is for example a PE/EPR mixture, the ratio by weight whereof can vary widely, for example between 40/60 and 90/10, said mixture being co-grafted with an anhydride, especially maleic anhydride, according to a graft rate for example of 0.01 to 5% by weight.

The functionalized polyolefin (B1) may be chosen from the following, maleic anhydride or glycidyl methacrylate grafted, (co)polymers wherein the graft rate is for example from 0.01 to 5% by weight:
of PE, of PP, of copolymers of ethylene with propylene, butene, hexene, or octene containing for example from 35 to 80% by weight of ethylene;
ethylene/alpha-olefin copolymers such as ethylene/propylene, EPR (abbreviation for ethylene-propylene-rubber) and ethylene/propylene/diene (EPDM).
styrene/ethylene-butene/styrene (SEBS), styrene/butadiene/styrene (SBS), styrene/isoprene/styrene (SIS), styrene/ethylene-propylene/styrene (SEPS) block copolymers.
ethylene and vinyl acetate copolymers (EVA), containing up to 40% by weight of vinyl acetate;
ethylene and alkyl (meth)acrylate copolymers, containing up to 40% by weight of alkyl (meth)acrylate;
ethylene and vinyl acetate (EVA) and alkyl (meth)acrylate copolymers, containing up to 40% by weight of comonomers.

The functionalized polyolefin (B1) may also be selected from ethylene/propylene copolymers with predominantly maleic anhydride grafted propylene then condensed with a mono-amine polyamide (or a polyamide oligomer) (products described in EP-A-0342066).

The functionalized polyolefin (B1) may also be a co- or terpolymer of at least the following units: (1) ethylene, (2) alkyl (meth)acrylate or vinyl ester of saturated carboxylic acid and (3) anhydride such as maleic anhydride or (meth)acrylic acid or epoxy such as glycidyl (meth)acrylate.

By way of example of functionalized polyolefins of the latter type, mention may be made of the following copolymers, where ethylene represents preferably at least 60% by weight and where the termonomer (the function) represents for example from 0.1 to 10% by weight of the copolymer:
ethylene/alkyl (meth)acrylate/(meth)acrylic acid or maleic anhydride or glycidyl methacrylate copolymers;
ethylene/vinyl acetate/maleic anhydride or glycidyl methacrylate copolymers;
ethylene/vinyl acetate or alkyl (meth)acrylate/(meth)acrylic acid or maleic anhydride or glycidyl methacrylate copolymers.
   In the preceding copolymers, (meth)acrylic acid can be salified with Zn or Li.

The term “alkyl (meth)acrylate” in (B1) or (B2) denotes C1 to C8 alkyl methacrylates and acrylates, and may be chosen from methyl acrylate, ethyl acrylate, n-butyl acrylate, isobutyl acrylate, 2-ethyl-hexyl acrylate, cyclohexyl acrylate, methyl methacrylate and ethyl methacrylate.

Moreover, the previously cited polyolefins (B1) may also be crosslinked by any appropriate method or agent (diepoxy, diacid, peroxide, etc.); the term functionalized polyolefin also comprises mixtures of the previously cited polyolefins with a difunctional reagent such as a diacid, dianhydride, diepoxy, etc. that can react with these or mixtures of at least two functionalized polyolefins that can react together.

The copolymers mentioned above, (B1) and (B2), may be copolymerized in a statistical or sequenced way and have a linear or branched structure.

The molecular weight, the index MFI, the density of these polyolefins may also vary widely, which the person skilled in the art will know. MFI, abbreviation for Melt Flow Index, is a measure of fluidity in the molten state. It is measured according to standard ASTM 1238.

Advantageously the non-functionalized polyolefins (B2) are selected from homopolymers or copolymers of polypropylene and any ethylene homopolymer or ethylene copolymer and a higher alpha-olefin comonomer such as butene, hexene, octene or 4-methyl-1-pentene. Mention may be made for example of PPs, high-density PEs, medium-density PEs, linear low-density PEs, low-density PEs, very low-density PEs. These polyethylenes are known by the person skilled in the art as being produced according to a “free-radical” method, according to a “Ziegler” catalysis method, or, more recently, a so-called “metallocene” catalysis.

Advantageously the functionalized polyolefins (B1) are chosen from any polymer comprising alpha-olefin units and units carrying polar reactive functions like epoxy, carboxylic acid or carboxylic acid anhydride functions. By way of examples of such polymers, mention may be made of terpolymers of ethylene, of alkyl acrylate and of maleic anhydride or of glycidyl methacrylate like Lotader® from the Applicant or polyolefins grafted by maleic anhydride like Orevac® from the Applicant and terpolymers of ethylene, alkyl acrylate and (meth)acrylic acid. Mention may also be made of homopolymers or copolymers of polypropylene grafted by a carboxylic acid anhydride then condensed with polyamides or monoamine polyamide oligomers.

Advantageously, said composition constituting said sealing layer(s) is devoid of polyether block amide (PEBA). In this embodiment, PEBAs are therefore excluded from impact modifiers.

Advantageously, said transparent composition is devoid of core-shell particles or core-shell polymers.

Core-shell particle must be understood as a particle whose first layer forms the core and the second or all following layers form the respective shells.

The core-shell particle may be obtained by a method with several steps comprising at least two steps. Such a method is described for example in documents US2009/0149600 or EP0,722961.

In one embodiment, when the polyamide of the composition is a semi-aromatic polyamide, the proportion of impact modifier is then from 0 to less than 10% by weight, especially from 0 to 8% by weight, in particular from 1 to less than 10% by weight, especially from 1 to 8% by weight.

Advantageously, in this last embodiment, said composition also comprises from 0.1 to 5% by weight of additives.

### Regarding the Plasticizer:

The plasticizer may be a plasticizer commonly used in compositions based on polyamide(s).

Advantageously, use is made of a plasticizer which has good thermal stability so that it does not form fumes during the steps of mixing the different polymers and transforming the composition obtained.

In particular, this plasticizer may be selected from:

benzenesulfonamide derivatives, such as n-butyl benzenesulfonamide (BBSA),
the ortho and para isomers of ethyl toluenesulfonamide (ETSA), N-cyclohexyl toluenesulfonamide and N-(2-hydroxypropyl)benzenesulfonamide (HP-BSA),
esters of hydroxybenzoic acids, such as 2-ethylhexyl para-hydroxybenzoate (EHPB) and 2-decylhexyl para-hydroxybenzoate (HDPB),
esters or ethers of tetrahydrofurfuryl alcohol, such as oligoethyleneoxytetrahydrofurfuryl alcohol, and
esters of citric acid or hydroxymalonic acid, such as oligoethyleneoxymalonate.

A preferred plasticizer is n-butyl benzenesulfonamide (BBSA).

Another, more particularly preferred plasticizer is N-(2-hydroxypropyl)benzenesulfonamide (HP-BSA). Indeed, the latter has the advantage of preventing the formation of deposits at the extrusion screw and/or die (“die drool”) during a step of transformation by extrusion.

Of course, it is possible to use a mixture of plasticizers.

### Regarding the Additives

The additives may be chosen from an antioxidant, a heat stabilizer, a UV absorber, a light stabilizer, a lubricant, an inorganic filler, a flame retardant agent, a nucleating agent and a dye.

### Regarding the Structure

According to another aspect, the present invention relates to a multilayer structure comprising at least one sealing layer (1) as defined hereinbefore.

During contact of the hydrogen with said sealing layer, the total proportion of said contaminants extracted and present in the hydrogen is less than or equal to 3% by weight, in particular less than 2% by weight of the sum of the constituents of the composition constituting said sealing layer, determined according to the test defined in standard CSA/ANSI CHMC 2:19.

In a first embodiment, said multilayer structure corresponds to a tank and further comprises at least one composite reinforcement layer (2), said sealing layer being in contact with the hydrogen.

### First Embodiment: Tank

Said multilayer structure can therefore comprise at least one sealing layer and at least one composite reinforcement layer that is wound around the sealing layer and which may or may not adhere to one another.

In one embodiment, at least one of said composite reinforcement layers (2) consists of a fibrous material in the form of continuous fibers, impregnated with a composition predominantly comprising at least one polymer P2j (j=1 to m, m being the number of reinforcement layers), in particular an epoxide resin or epoxide-based resin, said structure being devoid of an outermost layer and adjacent to the outermost layer of polyamide polymer composite reinforcement.

Advantageously, said sealing layer and reinforcement layers do not adhere to one another and consist of compositions that respectively comprise different polymers.

Nevertheless, said different polymers may be of the same type.

Thus, if one of the two composite reinforcing and sealing layers is made of a composition comprising an aliphatic polyamide, then the other layer is made of a composition comprising a polyamide which is not aliphatic and which is for example a semi-aromatic polyamide so as to have a high-Tg polymer as the matrix of the composite reinforcement.

Said multilayer structure may comprise up to 10 sealing layers and up to 10 composite reinforcing layers of different natures.

It is obvious that said multilayer structure is not necessarily symmetrical and that it may therefore comprise more sealing layers than composite layers or vice versa, but there can be no alternation of layers and reinforcement layer.

Advantageously, said multilayer structure comprises one, two, three, four, five, six, seven, eight, nine or ten sealing layers and one, two, three, four, five, six, seven, eight, nine or ten composite reinforcing layers.

Advantageously, said multilayer structure comprises one, two, three, four or five sealing layers and one, two, three, four or five composite reinforcing layers.

Advantageously, said multilayer structure comprises one, two or three sealing layers and one, two, or three composite reinforcing layers.

In one embodiment, said multilayer structure comprises a single sealing layer and several reinforcement layers, said adjacent reinforcement layer being wound around said sealing layer and the other reinforcement layers being wound around the directly adjacent reinforcement layer.

In another embodiment, said multilayer structure comprises a single reinforcing layer and several sealing layers, said reinforcing layer being would around said adjacent sealing layer.

In one advantageous embodiment, said multilayer structure comprises a single sealing layer and a single composite reinforcement layer, said reinforcement layer being wound around said sealing layer.

All combinations of these two layers are therefore within the scope of the invention, with the proviso that at least said innermost composite reinforcement layer is wound around said outermost adjacent sealing layer, the other layers adhering or not to one another.

Advantageously, in said multilayer structure, each sealing layer consists of a composition comprising the same type of polyamide.

The expression “same type of polymer” means, for example, a polyamide which may be the same or a different polyamide depending on the layers.

Advantageously, in said multilayer structure, each reinforcement layer consists of a composition comprising the same type of polymer P2j, in particular an epoxy resin or epoxy-based resin.

Advantageously, in said multilayer structure, each sealing layer comprises the same type of polyamide and each reinforcement layer comprises the same type of polymer P2j, in particular an epoxide resin or epoxide-based resin.

Advantageously, the polyamide P2j is identical for all the reinforcement layers.

Advantageously, said polymer P2j is an epoxide resin or an epoxide-based resin.

Advantageously, the polyamide is identical for all the sealing layers.

Advantageously, said polyamide of the sealing layer is an aliphatic polyamide, in particular PA6, PA66, PA610, PA612, PA1010, PA 1012, PA 1212, PA11, PA12, especially PA 11 or PA12, and said polymer P2j is a semi-aromatic polyamide, in particular selected from among a PA MPMDT/6T, a PA11/10T, a PA 11/BACT, a PA 5T/10T, a PA 11/6T/10T, a PA MXDT/10T, a PA MPMDT/10T, a PA BACT/10T, a PA BACT/6T, PA BACT/10T/6T, a PA 11/BACT/6T, a PA 11/MPMDT/6T, a PA 11/MPMDT/10T, PA 11/BACT/10T, a PA and 11/MXDT/10T.

In one embodiment, said multilayer structure consists of a single reinforcement layer and a single sealing layer wherein said polyamide of the sealing layer is a long-chain aliphatic polyamide, in particular PA1010, PA 1012, PA 1212, PA11, PA12, especially PA 11 or PA12, and said polymer P2j is a semi-aromatic polyamide, in particular selected from a PA MPMDT/6T, a PA11/10T, a PA 11/BACT, a PA 5T/10T, a PA 11/6T/10T, a PA MXDT/10T, a PA MPMDT/10T, a PA BACT/10T, a PA BACT/6T, a PA BACT/10T/6T, a PA 11/BACT/6T, PA 11/MPMDT/6T, PA 11/MPMDT/10T, PA 11/BACT/10T, and a PA 11/MXDT/10T.

A long-chain polyamide is a polyamide having an average number of carbon atoms per nitrogen atom greater than 8.

In another embodiment, said multilayer structure consists of a single reinforcement layer and a single sealing layer wherein said polyamide of the sealing layer (1) is a long-chain aliphatic polyamide, in particular PA1010, PA 1012, PA 1212, PA12, especially PA 12, and said polymer P2j is a semi-aromatic polyamide, in particular chosen from a PA MPMDT/6T, a PA PA11/10T, a PA 11/BACT, a PA 5T/10T, a PA 11/6T/10T, a PA MXDT/10T, a PA MPMDT/10T, a PA BACT/10T, a PA BACT/6T, PA BACT/10T/6T, a PA 11/BACT/6T, PA 11/MPMDT/6T, PA 11/MPMDT/10T, PA 11/BACT/10T and a PA 11/MXDT/10T.

In yet another embodiment, the multilayer structure consists of a single reinforcement layer and a single sealing layer wherein said polyamide of the sealing layer (1) is a long-chain aliphatic polyamide, in particular PA1010, PA 1012, PA 1212, PA11, PA12, or semi-aromatic, in particular chosen from polyamide 11/5T or 11/6T or the 11/10T, MXDT/10T, MPMDT/10T and BACT/10T, in particular PA11 or PA12 and said polymer P2j is an epoxide or epoxide-based resin.

In another embodiment, the multilayer structure consists of a single reinforcement layer and a single sealing layer wherein said polyamide of the sealing layer (1) is a long-chain aliphatic polyamide, in particular PA1010, PA 1012, PA 1212, PA12, or semi-aromatic, in particular chosen from polyamide 11/5T or 11/6T or 11/10T, MXDT/10T, MPMDT/10T and BACT/10T, in particular PA12 and said polymer P2j is an epoxide or epoxide-based resin.

Advantageously, said multilayer structure further comprises at least one outer layer consisting of a fibrous material made of continuous glass fiber impregnated with a transparent amorphous polymer, said layer being the outermost layer of said multilayer structure.

Said outer layer is a second reinforcement layer but transparent which makes it possible to be able to place text on the structure.

In a second embodiment, said multilayer structure corresponds to a pipe and further comprises at least one outer metal braid (2′), said sealing layer being in contact with the hydrogen.

There is therefore no composite reinforcement layer in this last embodiment.

This pipe is especially intended to connect the tank defined hereinbefore to the fuel cell.

The features of the sealing layer are identical to above.

### Regarding the Fibrous Material

Regarding the fibers making up said fibrous material, they are in particular mineral, organic or plant fibers.

Advantageously, said fibrous material may be sized or unsized.

Said fibrous material can therefore comprise up to 3.5% by weight of an organic material (of thermosetting or thermoplastic resin type), referred to as sizing.

The mineral fibers include carbon fibers, glass fibers, basalt or basalt-based fibers, silica fibers, or silicon carbide fibers, for example. The organic fibers include thermoplastic or thermosetting polymer-based fibers, such as semi-aromatic polyamide fibers, aramid fibers or polyolefin fibers, for example. Preferably, they are amorphous thermoplastic polymer-based and have a glass transition temperature Tg higher than the Tg of the polymer or thermoplastic polymer mixture constituting the pre-impregnation matrix when the latter is amorphous, or higher than the Tm of the polymer or thermoplastic polymer mixture constituting the pre-impregnation matrix when the latter is semi-crystalline. Advantageously, they are semi-crystalline thermoplastic polymer-based and have a melting temperature Tm higher than the Tg of the polymer or thermoplastic polymer mixture constituting the pre-impregnation matrix when the latter is amorphous, or higher than the Tm of the polymer or thermoplastic polymer mixture constituting the pre-impregnation matrix when the latter is semi-crystalline. Thus, there is no melting risk for the organic fibers constituting the fibrous material during the impregnation by the thermoplastic matrix of the final composite. The plant fibers include natural linen, hemp, lignin, bamboo, silk, in particular spider silk, sisal, and other cellulose-based fibers, in particular viscose-based. These plant fibers can be used pure, treated or coated with a coating layer, in order to facilitate the adherence and impregnation of the thermoplastic polymer matrix.

The fibrous material may also be a fabric, braided or woven with fibers.

It may also correspond to fibers with support threads.

These component fibers may be used alone or in mixtures. Thus, organic fibers may be mixed with the mineral fibers to be pre-impregnated with thermoplastic polymer powder and to form the pre-impregnated fibrous material.

The organic fiber strands may have several grammages. They can further have several geometries. The component fibers of the fibrous material can further assume the form of a mixture of these reinforcing fibers with different geometries. The fibers are continuous fibers.

Preferably, the fibrous material is selected from glass fibers, carbon fibers, basalt fibers or basalt-based fibers, or a mixture thereof, in particular carbon fibers.

It is used in the form of one strand or several strands.

According to another aspect, the present invention relates to a method of manufacturing a multilayer structure as defined above, characterized in that it comprises a step of manufacturing a sealing layer (1) as defined in one of claims 1 to 12, by injection, extrusion, extrusion blow molding or rotational molding.

In one embodiment, said method comprises a prior step of washing the polyamide of the composition at least once with a system selected from a polar solvent, in particular methanol, water or water vapor, or a mixture thereof.

Advantageously, said method of manufacturing a multilayer structure which corresponds to a tank and as defined above, is characterized in that it comprises a step of filament winding of a reinforcement layer (2), as defined above, around the sealing layer (1).

Advantageously, said multilayer structure can be washed, after manufacture, at least once with a system selected from a polar solvent, in particular methanol, water or water vapor, or a mixture thereof.

In the case of washing after manufacture with a polar solvent, in particular methanol or with a water/polar solvent mixture, it is necessary to rinse the structure to completely remove any trace of methanol.

Advantageously, the structure is dried for 2 days under a current of dry air, especially at a temperature comprised from 40° C. to 80° C., in particular from 50° C. to 70° C., especially at 60° C. after manufacture or after manufacture and washing.

All the features detailed above also apply to the method.

### EXAMPLES

The following compositions were prepared according to techniques well known to a person skilled in the art for the composition of the sealing layer (1) of the structures of the invention (Table 2).

TABLE 2

| Composition | I1 | I2 | I3 | I4 | I5 | C1 | C2 |
|---|---|---|---|---|---|---|---|
| PA11 | 100% | | 99.7% | 90% | 89.7% | 86% | |
| PA11/10T | | 70% | | | | | 65% |
| Plasticizer | 0 | 0% | 0 | 0 | 0 | 13% | 10% |
| Impact | 0% | 30% | 0% | 10% | 10% | 0% | 35% |
| modifier | | | | | | | |
| additives | 0% | 0% | 0.3% | 0% | 0.3% | 0% | 0% |

I1 to I2: compositions of the invention
C1 to C2: comparative compositions
PA11: PA11 is a polyamide 11 having an Mn (number-average molecular weight) of 45,000. The melting temperature is 190° C.; its melting enthalpy is 56 J/g.

### PA11/10T: Rilsan HT (Arkema)

Plasticizer: BBSA (n-butylbenzenesulfonamide)
Impact modifier: Lotader® 4700 (50%)+Lotader® AX8900 (25%)+Lucalene® 3110 (25%)
Additives: stabilizers

The sealing layers (liner) of the invention comprising a sealing layer (1) are obtained by rotational molding of the sealing layer (liner) with the various compositions above at a temperature suited to the nature of the thermoplastic resin used.

The multilayer structures comprising a composite reinforcement made of epoxide resin or epoxide-based resin are obtained by a process of wet filament winding, which consists of winding carbon fibers around the liner, which fibers have been previously pre-impregnated in a liquid epoxide bath or a bath based on liquid epoxide. The tank is then polymerized in an oven for 2 hours.

The contaminants extracted in the hydrogen from the various sealing layers of the multilayer structures manufactured from the compositions above were quantified according to standard CSA/ANSI CHMC 2:19:

Multilayer structure with sealing layer based on composition-11: <0.5%
Multilayer structure with sealing layer based on composition-12: <0.5%
Multilayer structure with sealing layer based on composition-13: <0.5%
Multilayer structure with sealing layer based on composition-14: <0.5%
Multilayer structure with sealing layer based on composition-15: <0.5%
Multilayer structure with sealing layer based on composition-C1: >3%
Multilayer structure with sealing layer based on composition-C2: >3%

1. A use of a sealing layer consisting of a composition comprising at least one polyamide for preparing a multilayer structure intended for the transport, the distribution or the storage of hydrogen, said sealing layer satisfying a test for contaminants present in the hydrogen and extracted from said sealing layer after contact of the hydrogen with same, said test being carried out as defined in the standard CSA/ANSI CHMC 2:19, the total proportion of said contaminants extracted in the hydrogen being less than or equal to 3% by weight of the sum of the constituents of said composition.

2. The use according to claim 1, wherein the extracted contaminants are selected from the plasticizers, the stabilizers, the oligomers, water, a fatty substance, volatile organic compounds and a mixture thereof.

3. The use according to claim 2, wherein the proportion by weight of each extracted individual contaminant is less than or equal to 1%.

4. The use according to claim 2, wherein the composition of the contaminants extracted is as follows:
up to 1% of plasticizers,
up to 0.5% of stabilizers,
up to 0.5% of oligomers,
up to 0.5% of water,
up to 0.5% of fatty substance, and
up to 0.5% of volatile organic compounds,
the sum of the extracted contaminants being less than or equal to 3% by weight of the sum of the constituents of said composition.

5. The use according to claim 1, wherein said composition comprises the following by weight:
at least 63.5% of polyamide,
from 0 to less than 30% of impact modifier,
from 0 to 1.5% of plasticizer, and
from 0 to 5% by weight of additives,
the sum of the constituents of the composition being equal to 100%.

6. The use according to claim 1, wherein the extracted contaminants are selected from the stabilizers, water, oil, volatile organic compounds and a mixture thereof.

7. The use according to claim 6, wherein the proportion by weight of each extracted individual contaminant is less than or equal to 0.5%.

8. The use according to claim 6, wherein the composition of the extracted contaminants is as follows:
up to 0.5% of stabilizers,
up to 0.5% of water,
up to 0.5% of fatty substance, and
up to 0.5% of volatile organic compounds,
the sum of the contaminants being less than or equal to 2% by weight of the sum of the constituents of said composition.

9. The use according to claim 6, wherein said composition comprises by weight:
at least 63.5% of polyamide,
from 0 to less than 30% of impact modifier, especially from 0 to less than 15% of impact modifier, and
from 0 to 5% by weight of additives,
the sum of the constituents of the composition being equal to 100%.

10. The use according to claim 1, wherein the polyamide is selected from an aliphatic polyamide, a semi-aromatic polyamide and a mixture thereof.

11. The use according to claim 10, wherein the polyamide is aliphatic and selected from PA6, PA66, PA11, PA12, PA610, PA612, PA1010, PA1012 and PA1212.

12. The use according to claim 10, wherein the polyamide is semi-aromatic and selected from polyamide 11/5T, 11/6T, 11/10T, MXDT/10T, MPMDT/10T and BACT/10T.

13. A multilayer structure comprising at least one sealing layer consisting of a composition comprising at least one polyamide for preparing a multilayer structure intended for the transport, the distribution or the storage of hydrogen, said sealing layer satisfying a test for contaminants present in the hydrogen and extracted from said sealing layer after contact of the hydrogen with same, said test being carried out as defined in the standard CSA/ANSI CHMC 2:19, the total proportion of said contaminants extracted in the hydrogen being less than or equal to 3% by weight of the sum of the constituents of said composition.

14. The multilayer structure according to claim 13, wherein it corresponds to a tank and further comprises at least one composite reinforcement layer, said sealing layer being in contact with the hydrogen.

15. The multilayer structure according to claim 13, wherein at least one of said composite reinforcement layers consists of a fibrous material in the form of continuous fibers impregnated with a composition predominantly comprising at least one polymer P2j, (j=1 to m, m being the number of reinforcement layers),
said structure being devoid of an outermost layer and adjacent to the outermost layer of polyamide polymer composite reinforcement.

16. The multilayer structure according to claim 13, wherein each sealing layer comprises the same type of polyamide.

17. The multilayer structure according to claim 13, wherein each reinforcement layer comprises the same type of polymer.

18. The multilayer structure according to claim 13, wherein each sealing layer comprises the same type of polyamide and each reinforcement layer comprises the same type of polymer.

19. The multilayer structure according to claim 13, wherein it has a single sealing layer and a single reinforcement layer.

20. The multilayer structure according to claim 13, wherein said structure further comprises at least one outer layer consisting of a fibrous material made of continuous glass fiber impregnated with a transparent amorphous polymer, said layer being the outermost layer of said multilayer structure.

21. The multilayer structure according to claim 13, wherein it corresponds to a pipe and further comprises at least one outer metal braid, said sealing layer being in contact with the hydrogen.

22. A method for manufacturing a multilayer structure as defined in claim 13, wherein it comprises a step of manufacturing a sealing layer by injection, extrusion, extrusion blow molding or rotational molding, the sealing layer consisting of a composition comprising at least one polyamide for preparing a multilayer structure intended for the transport, the distribution or the storage of hydrogen, said sealing layer satisfying a test for contaminants present in the hydrogen and extracted from said sealing layer after contact of the hydrogen with same, said test being carried out as defined in the standard CSA/ANSI CHMC 2:19, the total proportion of said contaminants extracted in the hydrogen being less than or equal to 3% by weight of the sum of the constituents of said composition.

23. The method for manufacturing a multilayer structure according to claim 22, wherein it comprises a prior step of washing the polyamide of the composition at least once with a system selected from a polar solvent, prior to the step of manufacturing said sealing layer by injection, extrusion or rotational molding.

24. The method for manufacturing a multilayer structure according to claim 22, wherein it comprises a step of filament winding of a reinforcement layer around the sealing layer.
